(19) United States
(12) Patent Application Publication
(10) Pub. No.: US 2006/0002559 A1
(43) Pub. Date: Jan. 5, 2006

(54) Method for preventing eavesdropping in wireless communication system

(75) Inventor: Seiji Kachi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/166,226

(22) Filed: Jun. 27, 2005

(30) Foreign Application Priority Data
Jun. 30, 2004 (JP) 2004-193840

(51) Int. Cl. H04K 1/00

(52) U.S. Cl. 380/270

(57) ABSTRACT

A wireless communication system includes an access point 101 and a terminal 102 exchanging, with the access point 101, a packet encrypted with an encryption key that has been previously set on the basis of a Wired Equivalent Privacy (WEP). When receiving the packet, the access point 101 determines whether the received packet includes a Weak Initial Vector (Weak IV) having a specified bit pattern. When the packet includes the Weak IV, the access point 101 transmits a disturbing signal for preventing the packet from being eavesdropped.

### BACKGROUND OF THE INVENTION

1. Field of the Invention

The present invention relates to a wireless communication system and a method for preventing eavesdropping (tapping) in a wireless communication system and particularly, to a wireless communication system and a method for preventing eavesdropping in a wireless communication system capable of transmitting a packet that disrupts an analysis process in an eavesdropping terminal.

2. Description of the Related Art

Wireless LAN systems are now widely used and make communication environment more convenient than the use of wired LAN systems.

In the wired LAN, a diffusion of a switching HUB makes it difficult to receive other people's data in itself, so that it has not been necessary for users to care for security.

In the wireless LAN, however, it is possible to receive other people's data, and the wireless LAN systems are dependent on a WEP code with regards to security for preventing the content from being read.

The vulnerability of a WEP system has been pointed out for several years and, nowadays, it is possible for anyone to obtain free software for cracking the WEP key.

The following three systems are mainly available as encryption systems used in the wireless LAN:

Wired Equivalent Privacy (WEP) 64/128

Temporal Key Integrity Protocol (TKIP)

Advanced Encryption Standard (AES)

Among the above encryption systems, the WEP system is the oldest and is implemented in approximately all wireless LAN equipment.

The WEP system is more advantageous than other two systems in terms of interoperability. However, an encryption protection becomes weaker when an Initialization Vector (IV) having a specified pattern is used, and the vulnerability thereof has been pointed out.

The IV having a specified pattern is called “Weak IV”. The document that points out the vulnerability in the Weak IV is disclosed and analysis tool for the Weak IV is disclosed as open source. As the document, the following non-patent document is adduced:
“Scott Fluhurer, Itsik Mantin, Adi shamir Weakness in the Key Scheduling Algorithm of RC4 (searched on Jun. 17, 2004)” <URL; http://www.drizzle.com/aboba/IEEE/rc4_ksaproc.pdf> As the analysis tool, Airsnort is adduced.

JPA 2004-015725 and JPA 2004-064531 can be taken as documents related to the present invention.

However, it is possible for an ordinary engineer having knowledge of Linux to crack the WEP by intercepting packets for several hours.

The TKIP and AES are new systems, so that there is little possibility that an encryption key is cracked when they are used. However, user's wireless LAN equipment may fail to conform to the new systems.

Although it may be unavoidable to utilize a more advanced technique such as the TKIP or AES in a public service such as a hot spot, the TKIP or AES is over-spec for the usage of only enjoying Web access in home. It is desirable to utilize WEP in terms of increase in the price of equipment and interoperability to existing equipment.

Further, more complicated processing is required and thereby more CPU power and memory space are required in the TKIP and AES than in the WEP. As above, the TKIP and AES are disadvantage in terms of cost.

Further, a protocol becomes more complicated in the TKIP and AES than in the case where the WEP is used, so that the slight setting miss will result in communication breakdown. In this regard, it is not easy for general users to handle the TKIP and AES. Special knowledge for trouble analysis is required in the TKIP and AES.

If it is possible to reconfigure all WLAN equipment, program installed in the equipment can be modified so as not to utilize the Weak IV. However, it is difficult to perform the above modification in embedded device or old equipment.

Although the disadvantage of the vulnerability can be avoided unless wireless LAN equipment uses the Weak IV in the first place, it is difficult to apply a modification for not using Weak IV to all the considerable number of equipment that have been shipped and it may be impossible to apply that to embedded equipment.

In the conventional eavesdropping system, an eavesdropping terminal tries to guess an encryption key on the basis that one encryption key is used.

Assuming that a password is “ABCDE”, if only this “ABCDE” is used as the password, the eavesdropping terminal guesses the password by the order like “..C..”→“.BC..”→“.BC.E.” when it receives packets having Weak IV and finally determines that the password is “ABCDE”. As a reconfirmation, the eavesdropping terminal decrypts a plurality of intercepted packets by the encryption key “ABCDE”, checks whether the original IP packets can be obtained or not, and finally determines that “ABCDE” is the password if the original IP packets can be obtained.

### SUMMARY OF THE INVENTION

An object of the present invention is to prevent decryption based on the Weak IV collection without reconfiguration of terminal equipment currently used.

According to a first aspect of the present invention, there is provided a method for preventing eavesdropping in a wireless communication system that includes an access point and a terminal exchanging, with the access point, a packet encrypted with an encryption key that has been previously set on the basis of a Wired Equivalent Privacy (WEP), the method comprising the steps of determining whether the packet includes a Weak Initial vector (Weak IV) having a specified bit pattern, when the access point receives the packet, and

transmitting a disturbing signal for preventing the packet from being decrypted, when the packet includes the Weak IV.

According to a second aspect of the present invention, there is provided a wireless communication system comprising an access point; and a terminal exchanging, with the access point, a packet encrypted with an encryption key that has been previously set on the basis of a Wired Equivalent Privacy (WEP),

the access point comprising determination unit for determining whether the received packet includes a Weak Initial Vector (Weak IV) having a specified bit pattern; and transmitter for transmitting a disturbing signal for preventing the packet from being decrypted,

wherein the transmitter transmits the disturbing signal when the determination unit determines that the received packet includes the Weak IV.

According to a third aspect of the present invention, there is provided an access point of a wireless communication system including the access point and a terminal exchanging, with the access point, a packet encrypted with an encryption key that has been previously set on the basis of a Wired Equivalent Privacy (WEP), the access point comprising:

determination unit for determining whether the received packet includes a Weak Initial Vector (Weak IV) having a specified bit pattern; and

transmitter for transmitting a disturbing signal for preventing the packet from being decrypted, wherein the transmitter transmits the disturbing signal when the determination unit determines that the received packet includes the Weak IV.

According to a fourth aspect of the present invention, there is provided a program product embodied on a storage unit of a computer and comprising code that, when the program product is executed, cause the computer to perform a method comprising the steps of: determining whether the packet includes a Weak Initial vector (Weak IV) having a specified bit pattern, when the access point receives the packet, and

transmitting a disturbing signal for preventing the packet from being decrypted, when the packet includes the Weak IV.

### BRIEF DESCRIPTION OF THE DRAWINGS

FIG. 1 is a block diagram showing a configuration of a wireless communication system according to an embodiment of the present invention;

FIG. 2 is a block diagram showing a configuration of an access point 101 according to the embodiment of the present invention;

FIG. 3 is a view showing a packet exchanged between the access point 101 and terminal 102;

FIG. 4 is a view showing an acknowledgement (ACK) to be transmitted for reception confirmation to the terminal 102 after the access point 101 has received a packet;

FIG. 5 is a view showing a disturbing signal transmitted from the access point 101;

FIG. 6 is a view showing a packet that has become trash data by the disturbing signal that the access point 101 generates;

FIG. 7 is a flowchart showing an operation of the access point 101 of the wireless LAN system according to the embodiment of the present invention;

FIG. 8 is a sequence diagram showing a packet communication between terminals; and

FIG. 9 is a sequence diagram showing another example of the operation of the access point 101 of the wireless LAN system according to the embodiment of the present invention.

### DETAILED DESCRIPTION OF THE PREFERRED EMBODIMENTS

A preferred embodiment of the present invention will be described below with reference to the accompanying drawings.

[Configuration]

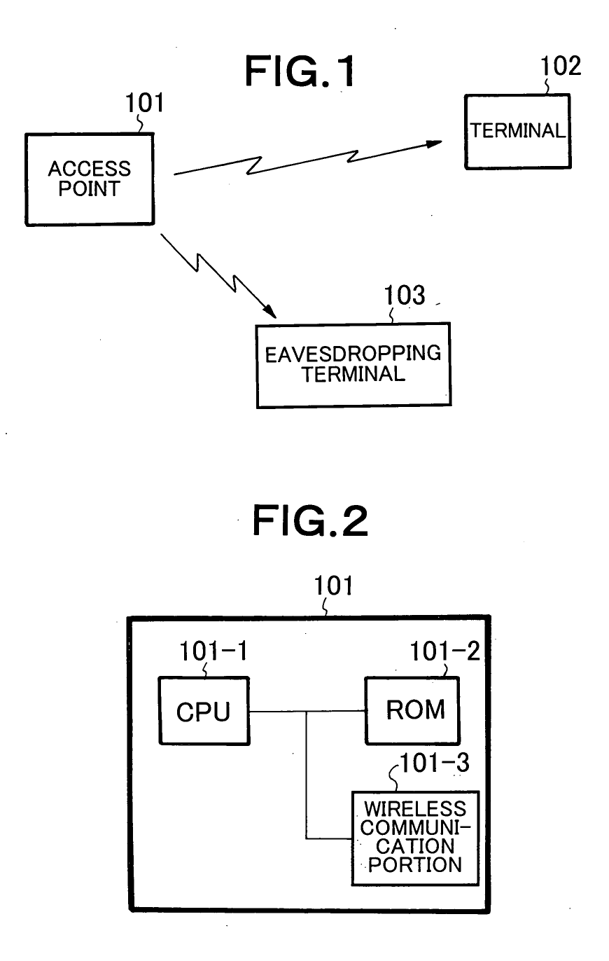

FIG. 1 is a block diagram showing a configuration of a wireless communication system according to an embodiment of the present invention.

As shown in FIG. 1, the wireless communication system according to the present embodiment includes access point 101 and terminal 102. The terminal 102 exchanges a packet with the access point 101. Here, the packets exchanged between the access point 101 and terminal 102 are eavesdropped by eavesdropping terminal 103.

The eavesdropping terminal 103 only receives the packets exchanged between the access point 101 and terminal 102 and does not perform any data transmission operation for the access point 101 and terminal 102.

FIG. 2 is a block diagram showing a configuration of the access point 101 according to the present embodiment.

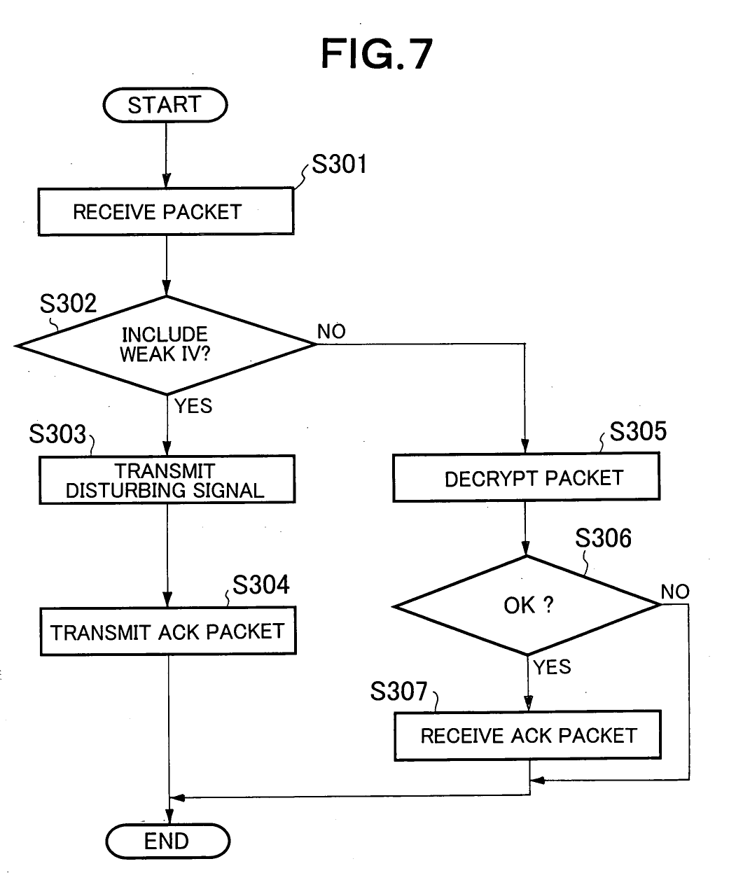

As shown in FIG. 2, the access point 101 includes CPU 101-1 that controls the entire system of the access point 101, ROM 101-2 that stores a control program of the CPU 101-1, and wireless communication portion 101-3 that performs a wireless communication. The access point 101 having the above configuration operates under the control of the CPU 101-1. The CPU 101-1 carries out information processings based on the program for performing the respective processings as described later by using FIG. 7. The wireless communication portion 101-3 comprises a transmitter and a receiver. The CPU 101-1 functions as a determination unit for determining whether the received packet includes Weak IV having a specified bit pattern. The access point 101 can be constructed as a computer. However, the access point 101 may be constructed by dedicated (exclusive use) ICs.

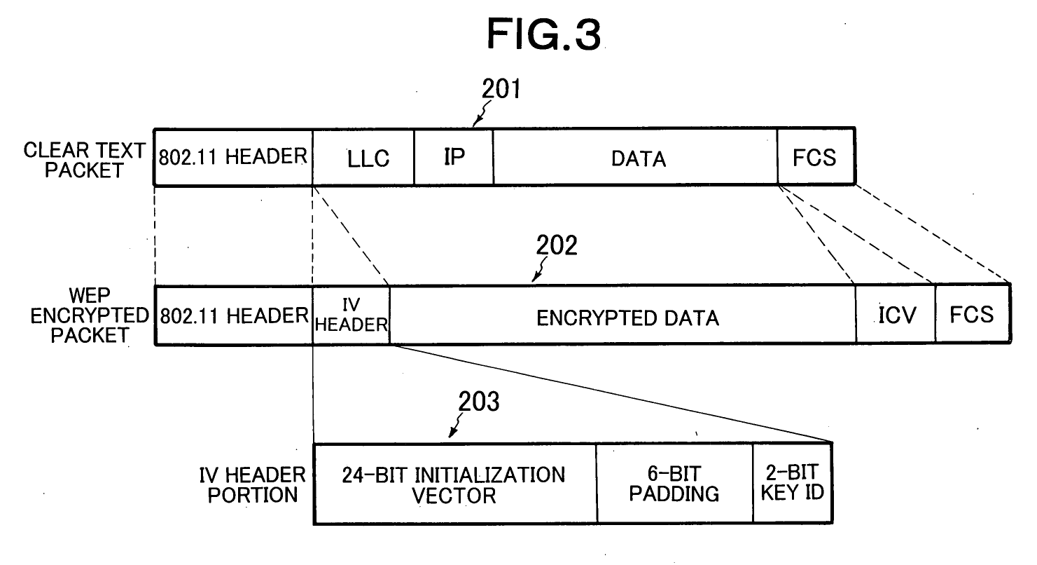

FIGS. 3, 4, and 5 are views each showing a packet exchanged in the wireless communication system according to the present embodiment.

FIG. 3 is a view showing a packet exchanged between the access point 101 and terminal 102.

In FIG. 3, clear text packet 201 is a packet that is not encrypted, and WEP encrypted packet 202 is a packet that has been encrypted with a WEP encryption method.

Initial vector (IV) header portion 203 denotes the details of the IV header portion in the WEP encrypted packet 202.

The clear text packet 201 is constituted by a 802.11 header, a Logical Link Control (LLC) header, an IP header, a data portion, and a Frame check sequence (FCS). A CRC-32 is generally used as the FCS in the wireless LAN system.

The WEP encrypted packet 202 is a packet obtained by encrypting the clear text packet 301 with the WEP encryption method. In this encryption, the IV header 203 and Integrity Check Value (ICV) are added to the clear text packet 201. In the present embodiment, each of the IV header 203 and ICV is 4 bytes.

The 802.11 header includes information indicating a destination and information indicating a source.

The IV is an initial value used at the time of packet encryption and is different from the encryption key. In general, the IV differs for each packet. When the same IV is used among packets, the intercepted packets exhibit regularity, so that the encryption key becomes easy to be guessed.

The IV header 203 is constituted by an Initialization Vector (IV), a padding, and a key ID. In the present embodiment, the IV is 24 bits, the padding is 6 bits, and the key ID is 2 bits.

The padding is data that compensate the shortage of data volume when data having the data volume are constructed as a certain size of format.

Among the 24 bit-IV, a value corresponding to the following bit patterns is Weak IV.

BBBBBB11, 11111111, XXXXXXXX

BBBBBB: key position exhibiting vulnerability

XXXXXXXX: optional (arbitrary) characters

For example, in the case where “BBBBBB”=“000000”, cracking on 0-th byte of the WEP key can be performed. In the case where “BBBBBB”=“000001”, cracking on 1-th byte of the WEP key can be performed.

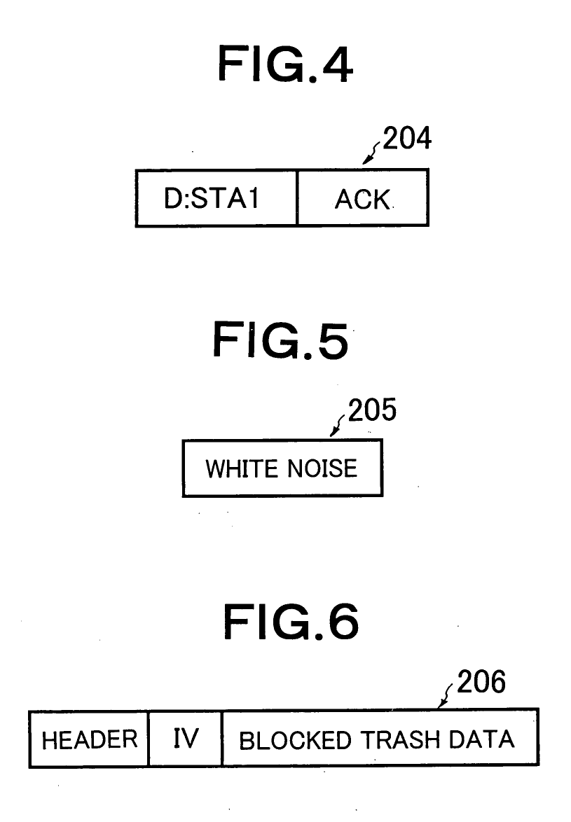

FIG. 4 shows an acknowledgement (ACK) packet that the access point 101 sends to the terminal 102 for reception confirmation if the access point 101 receives a packet.

As shown in FIG. 4, ACK packet 204 is constituted by a component denoting the destination and an ACK component. The destination component “D:STA1” denotes that the destination is the terminal 102.

FIG. 5 is a view showing a disturbing signal that the access point 101 transmits.

As shown in FIG. 5, disturbing signal 205 is white noise and blocks out data reception in an analog circuit.

FIG. 6 is a view showing packet 206 that has become trash data by the disturbing signal that the access point 101 generates.

As shown in FIG. 6, the parts of the packet 206 corresponding to the encrypted data, ICV, and FCS have become trash data.

The reception of the original encrypted data is blocked by the disturbing signal 205. Therefore, when the power of the disturbing signal becomes high, the blocked trash data 206 becomes substantially corresponding to white noise, disabling the decryption in the analog circuit.

In this case, the eavesdropping terminal 103 cannot receive the packet including Weak IV that the terminal 102 transmits to the access point 101. As a result, the decryption of the encryption key becomes impossible.

Even if the decryption in the analog circuit is possible and thereby the signal can be received as a packet, the bits of the packet are distorted by the disturbing signal.

In this case, the bit distortion is detected by the examination about the ICV or the FCS and discarded as an improper packet.

The eavesdropping terminal 103 thus cannot receive the packet including Weak IV, and the decryption of the encryption key becomes impossible.

[Operation]

FIG. 7 is a flowchart showing an operation of the access point 101 of the wireless LAN system according to the embodiment of the present embodiment.

A recent WLAN chip generally executes a sequence process using Digital Signal Processor (DSP) software, accordingly, the description will be made according to a flowchart.

As shown in FIG. 7, the access point 101 receives, from the terminal 102, a packet that has been encrypted with a WEP encryption method (step S301). The access point 101 then determines whether the IV of the received packet is Weak IV or not (step S302).

When the IV of the received packet is Weak IV. (Yes in step S302), the access point 101 transmits a disturbing signal (step S303).

The access point 101 transmits an ACK packet at the time point when the packet reception timing ends (step S304).

When the IV of the received packet is not Weak IV (No in step S302), the access point 101 decrypts the packet (step S305) and determines whether the WEP encrypted packet is correct or not (step S306). When the WEP encrypted packet is correct (Yes in step S306), the access point 101 transmits an ACK packet (step S307) and ends this flow.

When the WEP encrypted packet is not correct (No in step S306), the access point 101 does not transmit the ACK packet and ends this flow.

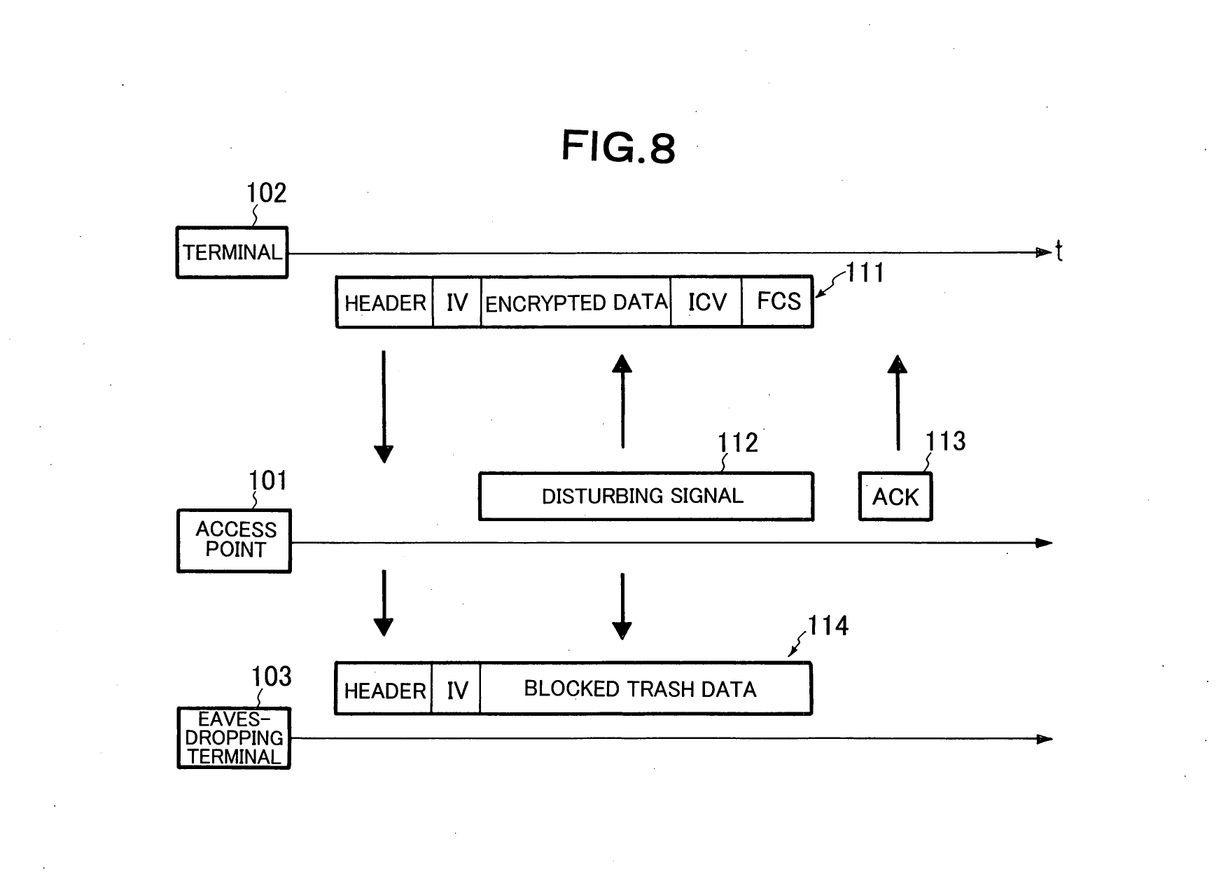

FIG. 8 is a sequence diagram showing a packet communication between terminals.

As shown in FIG. 8, the access point 101 transmits the disturbing signal only when the IV of the received packet is Weak IV so as to prevent the eavesdropping terminal 103 from receiving the encrypted data. In the packet 114 that the eavesdropping terminal receives, the parts corresponding to the encrypted data, ICV, and FCS become trash data by the disturbing signal 112.

Packets that have been encrypted with an encryption key are exchanged.

In the present embodiment, the packet 111 that the access point 101 receives is the same as that the eavesdropping terminal 103 receives. Therefore, the received packet in the access point 101 is discarded.

Accordingly, the access point 101 does not return an ACK in a normal operation. When the access point 101 does not return the ACK, the terminal 102 retransmits the packet 111 according to a normal protocol in the wireless LAN.

The reception of the retransmitted packet is also blocked by the disturbing signal, so that the access point 101 cannot receive the packet no matter how many times the terminal 102 retransmits the packet.

The number of times of the retransmission is set to about 4 in general. When the number of retransmission exceeds the set value, the terminal 102 stops the transmission.

Therefore, when transmitting the disturbing signal for the packet having Weak IV, the access point 101 forcibly transmits ACK 113 in order to prevent the retransmission.

The access point 101 returns the ACK 113 although the packet transmission has not normally been completed, so that a packet lack occurs. However, the packet lack occurs only in the case of Weak IV and its occurrence frequency is extremely low.

Further, since some amount of packet lack is inherently acceptable in the LAN, the packet lack in the case of Weak IV can be ignored for practical purposes.

[Another Operation]

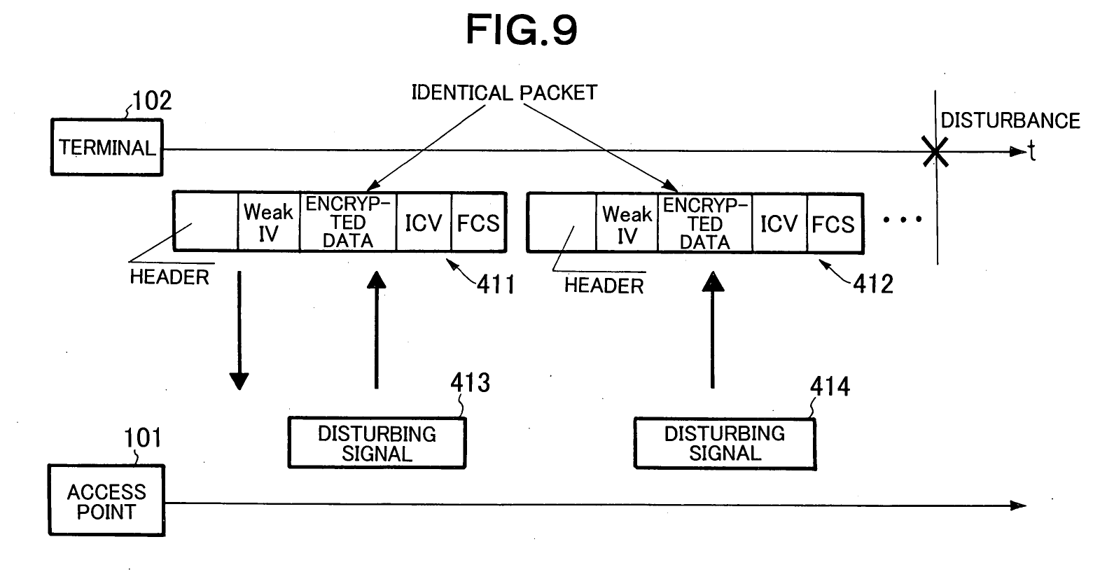

FIG. 9 is a sequence diagram showing another example of the operation of the access point 101 of the wireless LAN system according to the present embodiment.

Although an ACK packet is transmitted after the packet reception process in the operation described above, the ACK packet is not transmitted in this operation.

WEP encrypted packet 411 having Weak IV transmits from wireless LAN terminal 102. Upon detecting Weak IV of the received packet, the access point 101 transmits disturbing signal 413.

The access point 101 outputs the disturbing signal while the access point 101 itself receives the packet 411, with the result that the access point 101 cannot receive the packet 411 normally. Accordingly, the access point 101 does not transmit the ACK packet. The wireless LAN terminal 102 cannot receive the ACK packet, so that it retransmits a packet 412 identical to the packet 411. The packet 412 identical to the packet 411 also has Weak IV, so that the access point 101 transmits disturbing signal 414.

The wireless LAN terminal 102 and access point 101 repeat the above operation. Ultimately, the wireless LAN terminal 102 ends in a failure (disturbance) state after the retransmission limit.

When the failure occurs, an application is forcibly shut down as a communication failure in general. However, since the operation at the time of the failure differs from one terminal to another, another operation may be carried out.

Thus, by transmitting the ACK 113 as shown in FIG. 8, it is possible to avoid the vulnerability of the WEP while preventing the application shut-down.

In the present embodiment, it is possible to prevent decryption based on the Weak IV collection without reconfiguration of the existing wireless LAN equipment and terminal equipment currently used.

What is claimed is:

1. A method for preventing eavesdropping in a wireless communication system that includes an access point and a terminal exchanging, with said access point, a packet encrypted with an encryption key that has been previously set on the basis of a Wired Equivalent Privacy (WEP), said method comprising the steps of:
determining whether the packet includes a Weak Initial vector (Weak IV) having a specified bit pattern, when said access point receives the packet, and
transmitting a disturbing signal for preventing the packet from being decrypted, when the packet includes the Weak IV.

2. The method according to claim 1, wherein said access point transmits an acknowledgement (ACK) packet after transmitting the disturbing signal.

3. A wireless communication system comprising:
an access point; and
a terminal exchanging, with said access point, a packet encrypted with an encryption key that has been previously set on the basis of a Wired Equivalent Privacy (WEP),
said access point comprising:
determination unit for determining whether the received packet includes a Weak Initial Vector (Weak IV) having a specified bit pattern; and
transmitter for transmitting a disturbing signal for preventing the packet from being decrypted,
wherein said transmitter transmits the disturbing signal when said determination unit determines that the received packet includes the Weak IV.

4. The wireless communication system according to claim 3, wherein
said transmitter further transmits an acknowledgement (ACK) packet and
the ACK packet is transmitted after the transmission of the disturbing signal.

5. An access point of a wireless communication system including the access point and a terminal exchanging, with said access point, a packet encrypted with an encryption key that has been previously set on the basis of a Wired Equivalent Privacy (WEP), said access point comprising:
determination unit for determining whether the received packet includes a Weak Initial Vector (Weak IV) having a specified bit pattern; and
transmitter for transmitting a disturbing signal for preventing the packet from being decrypted,
wherein said transmitter transmits the disturbing signal when said determination unit determines that the received packet includes the Weak IV.

6. The access point according to claim 5, wherein said transmitter further transmits an acknowledgement (ACK) packet and the ACK packet is transmitted after the transmission of the disturbing signal.

7. A program product embodied on a storage unit of a computer and comprising code that, when said program product is executed, cause said computer to perform a method comprising the steps of:
determining whether the packet includes a Weak Initial vector (Weak IV) having a specified bit pattern, when said access point receives the packet, and
transmitting a disturbing signal for preventing the packet from being decrypted, when the packet includes the Weak IV.
